(19) United States
(12) Patent Application Publication
(10) Pub. No.: US 2019/0089463 A1
(43) Pub. Date: Mar. 21, 2019

(54) USING MULTI-LEVEL MODULATED SIGNALS IN PASSIVE OPTICAL NETWORKS

(71) Applicant: ZTE Corporation, Shenzhen (CN)

(72) Inventors: Junwen Zhang, Louisville, CO (US); Jun Shan Wey, Sammamish, WA (US); Weiliang Zhang, Shanghai (CN); Dan Geng, Shanghai (CN)

(21) Appl. No.: 16/132,338

(22) Filed: Sep. 14, 2018

(30) Foreign Application Priority Data
Sep. 15, 2017 (CN) PCT/CN2017/101865

(51) Int. Cl. H04B 10/516; H04B 10/27; H04L 25/02

(52) U.S. Cl. CPC H04B 10/5161; H04L 25/0202; H04B 10/27

(57) ABSTRACT

An optical communication method includes performing registration of an optical network unit using optical communication that uses an on-off key based modulation, performing, upon completion of the registration, link estimation, and using a multi-level modulation scheme, whose parameters are based on the link estimation, to perform subsequent communication with the optical network unit.

### CROSS REFERENCE TO RELATED APPLICATIONS

This patent document claims the benefit of priority under 35 U.S.C. § 119(a) and the Paris Convention of International Patent Application No. PCT/CN2017/101865, filed on Sep. 15, 2017. The entire content of the before-mentioned patent application is incorporated by reference as part of the disclosure of this patent document.

### TECHNICAL FIELD

This patent document relates to digital communication, and, in one aspect, optical communication systems that use multi-level modulated signals.

### BACKGROUND

There is an ever-growing demand for data communication in application areas such as wireless communication, fiber optic communication, and so on. The demands on core networks and access networks are increasing because user devices such as smartphones and computers are using more and more bandwidth due to multimedia applications, and because the number of devices carrying data is increasing. To maintain profitability and to meet increasing demand, equipment manufacturers and network operators need new techniques to increase efficiency and throughput of optical networks, as well as ways to reduce capital expenditures.

### SUMMARY

The present document discloses techniques for using different modulation schemes during the operation of a passive optical network. Among other benefits, the disclosed technique can be used in an embodiment that provides for the use of a first modulation scheme that facilitates low latency operation of messages exchanged between an optical line terminal (OLT) and an optical network unit (ONU) during the registration phase to facilitate quick admission of the ONU into the network. Once admitted, the communication can then switch to a higher efficiency multilevel modulation that provides more throughput for a given bandwidth. Methods, apparatuses, systems, and computer readable media are disclosed.

In one aspect, a method of digital communication id disclosed. The method includes performing, by an optical network unit, a registration of the optical network unit using optical communication that uses an on-off key based modulation, performing, upon completion of the registration, a channel estimation of a link between a remote transmitter of an optical line terminal and a receiver at the optical network unit, and using a multi-level modulation scheme, whose parameters are based on the channel estimation, to perform subsequent communication between the optical network unit and the optical line terminal. The following features may be included in various combinations. The multi-level scheme includes an N-level pulse amplitude modulation, wherein N is an integer. The channel estimation is based on a training frame received from the optical line terminal. The training frame is modulated according to a four level pulse amplitude modulation, and wherein the channel estimation determines an equalizer for the four level pulse amplitude modulation. After the equalizer is determined, a confirmation message is sent by the optical network unit to the optical line terminal. The method further includes sending, by the optical network unit, a training frame for another channel estimation between a transmitter at the optical network unit and a remote receiver at the optical line terminal. The registration includes receiving information about a discovery time slot and sending a registration request message during the discovery time slot to cause registration of the optical network unit.

In another aspect, another method of digital communication is disclosed. The method includes performing, by an optical line terminal, a registration of an optical network unit using optical communication that uses an on-off key based modulation, performing, upon completion of the registration, a channel estimation of a link between a transmitter at the optical network unit and a receiver at the optical line terminal, and using a multi-level modulation scheme, whose parameters are based on the channel estimation, to perform subsequent communication between the optical network unit and the optical line terminal. The following features may be included in various combinations. The optical line terminal communicates with a plurality of optical network units including the optical network unit, wherein communications to each of the plurality of optical network units is separated by time. The optical line terminal communicates with a plurality of optical network units including the optical network unit, wherein communications to each of the plurality of optical network units is separated by wavelength. The multi-level scheme includes an N-level pulse amplitude modulation, wherein N is an integer. The channel estimation is based on a training frame received from the optical network unit. The training frame is modulated according to a four level pulse amplitude modulation, and wherein the channel estimation determines an equalizer for the four level pulse amplitude modulation. After the equalizer is determined, a confirmation message is sent by the optical line terminal to the optical network unit. The registration includes sending information about a discovery time slot and receiving a registration request message during the discovery time slot to cause registration of the optical network unit.

In another aspect, an optical networking system is disclosed. The optical networking system includes an optical line terminal including a downstream optical transmitter, wherein the downstream optical transmitter transmits, in response to a request, a downstream equalizer training frame comprising modulated downstream symbols, an upstream optical receiver, wherein the upstream optical receiver receives an upstream equalizer training frame comprising modulated upstream symbols, and an upstream equalizer configured to equalize an upstream channel. The optical networking system may further include the following features in various combinations. The optical networking system further includes an optical network unit including a downstream optical receiver, wherein the downstream optical receiver receives the downstream equalizer training frame comprising the modulated downstream symbols, an upstream optical transmitter, wherein the upstream optical transmitter transmits, in response to another request, the upstream equalizer training frame comprising the modulated upstream symbols, and a downstream equalizer configured to equalize a downstream channel. An upstream registration is performed using an on-off keying modulation and a downstream registration is performed using a N-level pulse amplitude modulation (N-PAM), and wherein N is a positive integer. The downstream equalizer is trained via the downstream equalizer training frame before the upstream equalizer is trained via the upstream equalizer training frame. During the downstream registration the optical line terminal periodically or intermittently broadcasts the downstream equalizer training frame including training symbols and an indication of a time window when registration requests are processed. The optical network unit receives and processes the downstream equalizer training frame until the downstream equalizer is trained and able to perform registration. The optical network unit sends a registration request in the time window to the optical line terminal including an identifier associated with the optical network unit. The optical line terminal detects the registration request from the optical network unit, updates a dynamic bandwidth allocation, and sends a confirmation to the optical network unit. The optical network unit sends an acknowledgement (ACK) message to the optical line terminal to finish the downstream registration. The upstream equalizer training frame is sent from the optical network unit to the optical line terminal before the downstream equalizer training frame is sent from the optical line terminal to the optical network unit. The upstream equalizer training frame is sent from the optical network unit to the optical line terminal at a same time as the downstream equalizer training frame is sent from the optical line terminal to the optical network unit. Weights associated with the downstream equalizer are adjusted in response to the modulated downstream symbols received at the optical network unit. Weights associated with the upstream equalizer are adjusted in response to the modulated upstream symbols received at the optical line terminal. The upstream optical transmitter further transmits upstream payload data according to an on-off keying modulation or a multi-level pulse amplitude modulation, and wherein the downstream optical transmitter transmits downstream payload data according to the multi-level pulse amplitude modulation or the on-off keying modulation.

In yet another aspect, another method of digital communication is disclosed. The method includes communicating, between an optical line terminal and an optical network unit, link establishment information modulated according to an on-off keying modulation, and communicating, between the optical line terminal and the optical network unit, payload data modulated according to a multi-level pulse amplitude modulation. The method may include the following features in various combinations. The method is implemented by the optical line terminal. The method is performed by the optical network unit. The multi-level pulse amplitude modulation provides the payload data with a higher throughput that the on-off keying modulation.

### BRIEF DESCRIPTION OF THE DRAWINGS

FIG. 1 depicts an optical network, in accordance with some example embodiments.

FIG. 2 depicts data flow between an optical line terminal (OLT) and an optical network unit (ONU), in accordance with some example embodiments.

FIG. 3A depicts a process performed at an OLT for registration of an ONU, in accordance with some example embodiments.

FIG. 3B depicts a process performed at an ONU for registration of the ONU with an OLT, in accordance with some example embodiments.

FIG. 4A depicts a process at the OLT for downstream equalization training performed at ONUi, in accordance with some example embodiments.

FIG. 4B depicts a process at ONUi for downstream equalization training performed at ONUi, in accordance with some example embodiments.

FIG. 5A depicts a process at the OLT for upstream equalization training performed at the OLT, in accordance with some example embodiments.

FIG. 5B depicts a process at the ONUi for upstream equalization training performed at an OLT, in accordance with some example embodiments.

FIG. 6A depicts a process performed at an optical network unit, in accordance with some example embodiments.

FIG. 6B depicts another process performed at an optical line terminal, in accordance with some example embodiments.

FIG. 7 depicts an apparatus, in accordance with some example embodiments.

Where possible, like reference numeral refer to similar features.

### DETAILED DESCRIPTION

The fast-growing data and services, such as cloud, mobile front-haul and HD video streaming applications, drive the demand of higher bit-rate in short-range optical communications, such as inter- and intra-data center connection and optical access networks, which benefit from systems that can support higher capacity.

Cloud networking, 5G mobile fronthaul, and high bandwidth video applications, are driving the demand for increased capacity in access networks. Disclosed herein are passive optical networks (PON) with spectrally efficient, multilevel signal modulation formats, such as pulse-amplitude modulation (PAM) that may utilize digital signal processing (DSP) in addition to non-return to zero/on-off keying (NRZ/OOK). Some example embodiments provide multilevel modulation with increased spectral efficiency (SE) thereby reducing the cost per bit for the system using the same or similar optics as a system using NRZ/OOK.

Disclosed herein are methods, apparatuses, systems, and computer readable media for digital optical communication in passive optical networks (PONs). The disclosed optical communications may use modulations that carry more than one bit per symbol. Increasing the number of bits per symbol may increase the data throughput of the optical network at each node using a multi-bit per symbol modulation. As a base line, on-off keying (OOK) may produce one bit per symbol. An example of a multi-bit per symbol modulation includes pulse amplitude modulation such as PAM4 which has four levels (PAM4) and thus carries two bits per symbol. Higher order modulations may be used as well such as PAM8 (3 bits per symbol), PAM16, (four bits per symbol), PAM64 (eight bits per symbol), and so on. Other types of modulation may be used for multi-bit per symbol modulation as well such as pulse position modulation, phase shift keying (e.g., BPSK, QPSK, 8PSK, etc.), or any other digital modulation. The disclosed techniques can be implemented in optical transceivers that include an optical transmission/reception circuit.

In some implementations, channel equalization may be used to reduce the effects of imperfections such as optical distortions caused by the communications channel and other effects such as intersymbol interference which may be caused by non-linear optical and/or electrical drive components. Equalization may cause data latency due to training of the equalizer and/or processing by the equalizer. Training an equalizer may include training symbols that are a known series of symbols for the equalizer to determine the effects of the channel and other imperfections. From the transmitted training sequence passed through the imperfect channel and components, the equalizer determines how to undo the imperfections caused and accordingly how to correct later sent data. In some example embodiments, equalization is performed using digital signal processing.

In a PON system, some processes such as the registration of ONUs, may benefit from low-latency link communications, while other communications such as control/management may benefit from high reliability. In some example embodiments, registration and/or control/management information may use NRZ-OOK to reduce latency and/or increase reliability. In other embodiments, lower order multi-bit modulation may be used for applications requiring low latency or the high reliability.

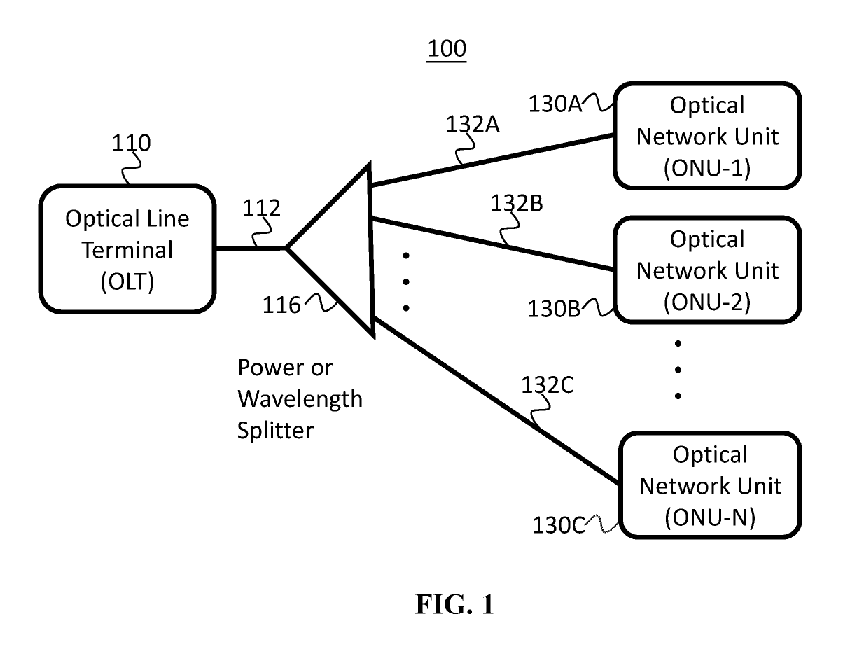

FIG. 1 depicts an optical network, in accordance with some example embodiments. Optical network 100 includes optical line terminal (OLT) 110 connected to wavelength or power splitter/combiner 116 (referred to herein as a splitter 116) via fiber 112, and optical network units 130A-130C connected to splitter 116 via fibers 132A-132C. Although FIG. 1 depicts splitter 116 multiplexing fiber 112 to three fibers 132A-132C, splitter 116 may multiplex fiber 112 to any other number of fibers such as eight, or 16, or 256, and so on.

OLT 110 may be located at a central location such as a central office of a network service provider. OLT 110 may include a plurality of optical transmitters and a plurality of optical receivers. The different optical transmitters and receivers may operate at different wavelengths, or multiple transmitters and receivers may operate at the same wavelength.

OLT 110 may include multiple transmitters. For example, OLT 110 may include optical transmitters to communicate with each ONU 130A-130C. Each transmitter may operate using a different wavelength. The different wavelengths may be carried by fiber 112 and demultiplexed by splitter 116 to multiple fibers such as fibers 132A-132C. In some example embodiments, one transmitter may generate a signal at a particular wavelength or may generate multiple wavelengths. In some implementations, a WDM may be included in OLT 110 to combine signals at different wavelengths onto fiber 112 which may be demultiplexed by wavelength by splitter 116. In another example, 256 OLT transmit signals may be demultiplexed by 116 from fiber 112 to 256 fibers connected to 256 ONUs. A wavelength division multiplexer may be the same device as a wavelength division demultiplexer. In another example, the optical transmitters may operate using one wavelength and the optical signals from the OLT 110 may be split by an optical power splitter 116. For example, 256 OLT transmit signals may be carried by fiber 112 and the power from fiber 112 may be split into 256 portions, one for each ONU. In another example, OLT may transmit signals for ONUs 130A-130C that may be carried from OLT 110 by fiber 112 and the power from fiber 112 may be split at 116 into portions and provided via fibers 132A-132C for each of ONUs 130A-130C.

OLT 110 may further include multiple receivers. For example, OLT 110 may include optical receivers to communicate with each ONU 130A-130C. Each receiver may operate using a different wavelength. The different wavelengths may be carried by multiple fibers such as fibers 132A-132C and multiplexed by splitter/combiner 116 onto fiber 112. In another example, 256 OLT receive signals carried by 256 fibers from 256 ONUs may be multiplexed by 116 onto fiber 112. At OLT 110, each optical signal (wavelength) may be coupled to a different optical detector or multiple wavelengths may be coupled to one detector. In another example, the optical receivers may operate using one wavelength and the optical signals from the multiple ONUs to the OLT 110 may be combined by an optical power combiner/splitter 116. For example, 256 OLT receive signals from 256 ONUs may be carried by 256 fibers to combiner 116 and combined onto fiber 112 to OLT 110. In another example, OLT receive signals from ONUs 130A-130C may be carried from ONUs 130A-130C by fibers 132A-132C to power combiner 116, and the combined signal provided to OLT 110 via fiber 112.

Signals passed from the OLT to an ONU may be referred to as a downstream signal, and signals passed from an ONU to the OLT may be referred to as an upstream signal. Power splitters may support time division multiple access (TDMA) where multiple links use the same fiber and signal transmissions are separated by time. WDMs support wavelength division multiple access (WDMA) where multiple links may use the same fiber and signals are separated by wavelength. Fiber 112 may pass signals from a plurality of transmitters and/or receivers in OLT 110. Splitter 116 may break-out the various wavelengths into separate fibers 132A-132C connected to each optical network unit such as 130A-130C. Although FIG. 1 depicts one OLT, one splitter 116, and three ONUs 130A-130C, optical network 100 may include more than on OLT, more than one splitter, and any number of connected ONUs.

Depending on the locations of the optical network units, optical network 100 may include fibers of substantial length. As an illustrative example, OLT 110 may be located at a central office. Fiber 112 may be 3 km long and connect OLT 110 to splitter 116. Splitter 116 may break-out the signals at various wavelengths into separate signals carried by separate fibers. For example, fiber 132A may connect splitter 116 to optical network unit 130A located 10 km from splitter 116 and carry signals to be received at optical network unit 130A at a first wavelength, and carry signals transmitted from optical network unit 130A on a second wavelength. Fiber 132B may connect splitter 116 to optical network unit 130B located 8 km from splitter 116 and carry signals to be received at optical network unit 130B at a third wavelength, and carry signals transmitted from optical network unit 130B on a fourth wavelength. Fiber 132C may connect splitter 116 to optical network unit 130C located 20 km from splitter 116 and carry signals to be received at optical network unit 130C at a fifth wavelength, and carry signals transmitted from optical network unit 130C on a sixth wavelength. Additional optical network units may be connected via additional fibers to splitter 116. The foregoing example indicated example distances and three optical network units, any other distances and/or number of optical network units may be used as well.

Each ONU may be connected to one or more fibers. For example, ONU 130A may be connected to fiber 132A. An optical network unit (ONU) may include an optical transmitter and an optical receiver. The optical transmitter may include an optical source that may be modulated to include data. In some example embodiments, the optical source may be coupled to a semiconductor optical amplifier (SOA). The power output from the optical source may be adjusted via a bias voltage and the SOA may further adjust the optical power via gain in the SOA coupled to a fiber.

In some example embodiments, channel equalization may be used to reduce the effects of imperfections such as optical distortions caused by the communications channel and other effects. Equalization is used to “undo” the effects of the channel and imperfect components. Equalization may be performed on the transmissions received from ONUs 130A-130C. The same equalizer may be used for more than on the transmissions from ONUs 130A-130C, or a different equalizer may be used for the signal from each of the ONUs 130A-130C. For example, transmissions from ONU 130A may pass through a first equalizer at OLT 110 to correct the distortions in transmissions from ONU 130A due to the components in OLT 110, fiber 112, splitter 116, fiber 132A, and the transmitter at ONU 130A. OLT 110 may include another equalizer for transmissions from ONU 130B. The receiver at each ONU may include equalizers to “undo” the distortions and other imperfections between each corresponding ONU and the OLT.

In some implementations, a linear equalizer may be used to process an incoming signal with a linear filter. In some implementations, a minimum mean squared error (MMSE) equalizer may be used to minimize the mean squared error when estimating the received signal. In some implementations, a zero-forcing equalizer may be used to approximate the inverse of the channel with a linear filter. In some implementations, a decision feedback equalizer may be used that adds a filtered version of previous symbol estimates to a linear equalizer. In some implementations, an adaptive equalizer may be used. Any of the forgoing types of equalizers, or any other equalizer, may be used for any of the downstream and upstream equalizers.

The equalizer may be implemented in a digital signal processor as executable code or in a field-programmable gate array (FPGA), application-specific integrated circuit (ASIC) or other hardware. Equalization may require training of the equalizer. Training may include a series of symbols sent by a transmitter that are known in advance by the receiver. The equalizer may be trained based on the known symbols that are transmitted and the symbols that are received which may be distorted/imperfect due the channel and component imperfections. Training may include determining filter weights, time delays, and/or coefficients, or other parameters. Equalizer training takes time to perform. The equalizer may be periodically trained due to component aging or component changes or the replacement of components. For example, an equalizer may be trained once per day, or at any other interval.

Instead of, or in addition to, equalization at a receiver, pre-distortion may be used at the transmitter. For example, the training process may determine distortions and/or non-linearities that may be compensated for by pre-distorting the transmitted signal such that the result of the pre-distortion followed by the distortion/imperfections in the channel/components is a signal without distortion or with reduced distortion. Pre-distortion at the transmitter may be combined with equalization at the receiver.

Higher order modulations may rely on a lower distortion channel and/or more linear components more heavily than a lower order modulation. For example, four-level pulse amplitude modulation (PAM4) may rely on a lower distortion/nonlinearity channel and components than on-off keying (OOK).

For some types of messages where low latency and higher robustness is preferred, a lower order modulation such as OOK may be used. For example, the registration or discovery of ONUs, frame preamble, and communications performed before training is completed, may use lower order modulation such as NRZ-OOK. Registration of one or more ONUs with the OLT may be performed before payload data is sent. Registration of an ONU with an OLT is referred to as auto-discovery in some Institute for Electrical and Electronic Engineers (IEEE) Ethernet Passive Optical Network (E-PON) standards. As used herein, registration and auto-discovery are synonymous.

In some example embodiments, after ONU registration, the OLT may switch to a higher throughput mode with a higher order modulation such as a multi-level modulation format for payload data. In some example embodiments, use of the higher order modulation may include two steps. For example, the OLT may send a downstream training frame including multi-level modulated signals to the a registered ONU. A newly registered ONU may also send a upstream training frame to the OLT. After training the equalizers at the ONU and/or OLT, the system may switch to a higher throughput mode using multilevel modulation format for payload data.

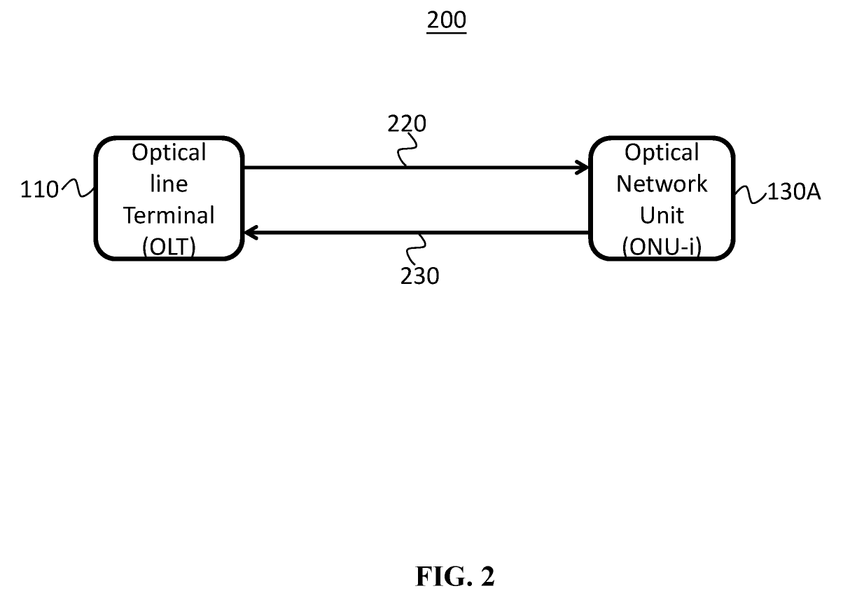

FIG. 2 depicts data flow between an optical line terminal (OLT) and an optical network unit (ONU), in accordance with some example embodiments. The description of FIG. 2 also refers to FIG. 1. In the example of FIG. 2, network 200 includes OLT 110 connected to ONU 130A. OLT 110 may communicate with optical network unit 130A by transmitting downstream signal 220 to ONU 130A and receiving upstream signal 230 from ONU 130A. FIG. 2 depicts information/data flow rather hardware components.

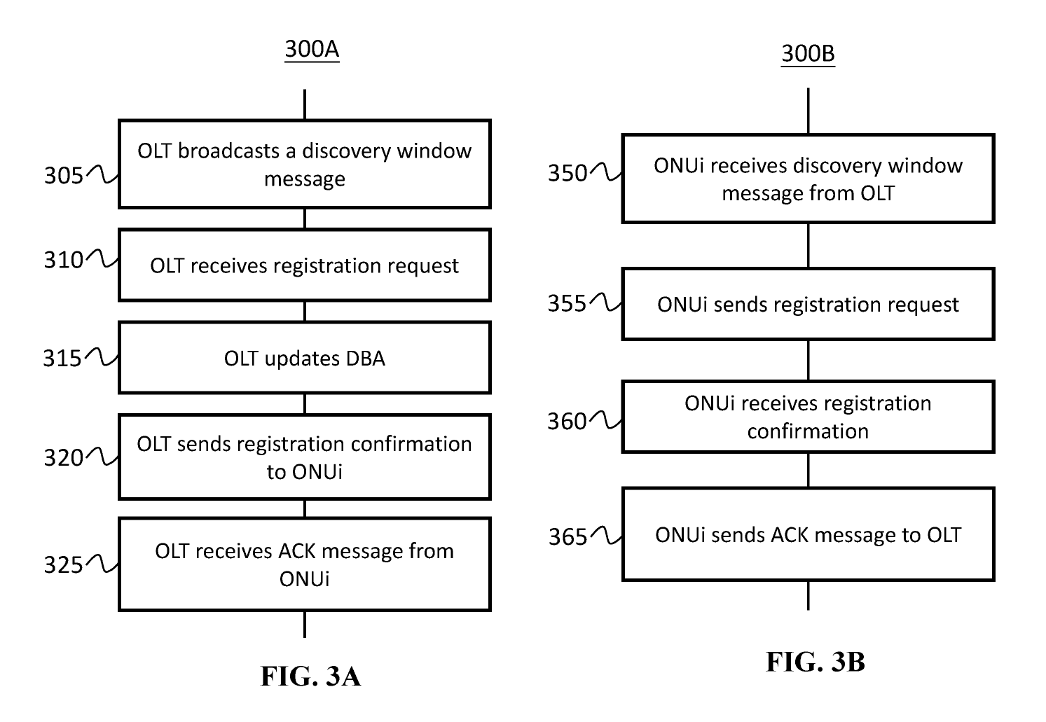

FIG. 3A depicts a process performed at an OLT for registration of an ONU, in accordance with some example embodiments. The description of FIG. 3A also refers to FIGS. 1 and 2. The process 300A may be performed at an OLT such as OLT 110 during the registration of an ONUi (the i^{th} ONU connected to the OLT) such as ONU 130A with an OLT. At 305, the OLT broadcasts a registration discovery window message identifying a time window when the OLT will accept registration requests. At 310, the OLT receives a registration request from an ONU. At 315, the OLT updates a dynamic bandwidth allocation (DBA) for each ONU connected to the OLT. At 320, the OLT sends a registration confirmation to the ONU that sent the request. At 325, the OLT receives a registration confirmation acknowledgement from the ONU.

At 305, the broadcast discovery window message may include an indication of a discovery window that may include one or more time slots within a recurring frame when the OLT will accept registration requests. The discovery window message may be broadcast using a lower order modulation such as NRZ-OOK. Accordingly, the discovery window broadcast message may be more robust against distortions and nonlinearities than a higher order modulation.

At 310, the OLT may receive a registration request from an ONUi. The registration request may be sent before equalizer training for a higher order modulation has been completed. By using NRZ-OOK or another low order modulation, robust communications can be assured for messages sent from the ONUi to the OLT.

At 315, the OLT may update a dynamic bandwidth allocation (DBA) for each ONUi connected to the OLT. Each ONUi connected to the OLT may request a bandwidth or data date. The OLT may reallocate bandwidth when registering a new ONUi in order to accommodate the added ONUi's required bandwidth. In some example embodiments, some ONUis may have higher priority, or the data carried by those ONUis may be of higher priority. DBA may allocate more bandwidth to higher priority ONUis or higher priority data. Upon registration, the OLT may store identifying information associated with the new ONUi.

At 320, the OLT may send a registration confirmation to the new ONUi that sent the request. For example, the OLT may have allocated bandwidth to the new ONUi. The registration confirmation may include information related to the bandwidth or data rate allocated to the new ONUi by the OLT. Other registration information may also be sent such as higher order modulations supported by the OLT. For example, information may be sent to the new ONUi indicating that the OLT supports PAM4, PAM8 and/or other higher order modulations.

At 325, the OLT may receive a registration confirmation acknowledgement from the ONUi. The acknowledgement may be a simple acknowledgement with no additional information or the acknowledgement may include additional information about the ONUi. For example, the registration acknowledgement may include which lower and higher order modulations are supported by the new ONUi, or other information about the ONUi.

FIG. 3B depicts a process performed at an ONU for registration of the ONU at an OLT, in accordance with some example embodiments. The description of FIG. 3B also refers to FIGS. 1, 2, and 3A. The process 300B may be performed at ONUi (the i^{th} ONU connected to the OLT) such as ONU 130A during the registration of ONUi with an OLT. At 350, an ONUi may receive a discovery window message sent from the OLT. At 355, ONUi may send a registration request in the corresponding window or time slot indicated by the registration window broadcast message. At 360, ONUi may receive a confirmation of registration from the OLT. At 365, ONUi may send a message to the OLT acknowledging the registration.

At 350, an ONUi may receive a discovery window message sent from the OLT. The discovery window message may include an indication of one or more time slots within a recurring frame when the OLT will accept registration requests. The discovery window message may be broadcast using a lower order modulation such as NRZ-OOK to ensure robustness against distortions and nonlinearities than a higher order modulation.

At 355, ONUi may send a registration request to the OLT in the corresponding window or time slot indicated by the registration window broadcast message. The registration request may be sent before equalizer training for a higher order modulation has been completed. By using NRZ-OOK or another low order modulation, robust communications can be assured for messages sent from the ONUi to the OLT.

At 360, ONUi may receive a confirmation of registration from the OLT. The registration confirmation may or may not include information other than the confirmation itself. For example, the registration message may include a bandwidth allocation and/or other registration information such as higher order modulations supported by the OLT.

At 365, ONUi may send a message to the OLT acknowledging the registration. The acknowledgement may be a simple acknowledgement with no additional information or the acknowledgement may include additional information about the ONU. For example, the registration acknowledgement may include which lower and higher order modulations are supported by the new ONU.

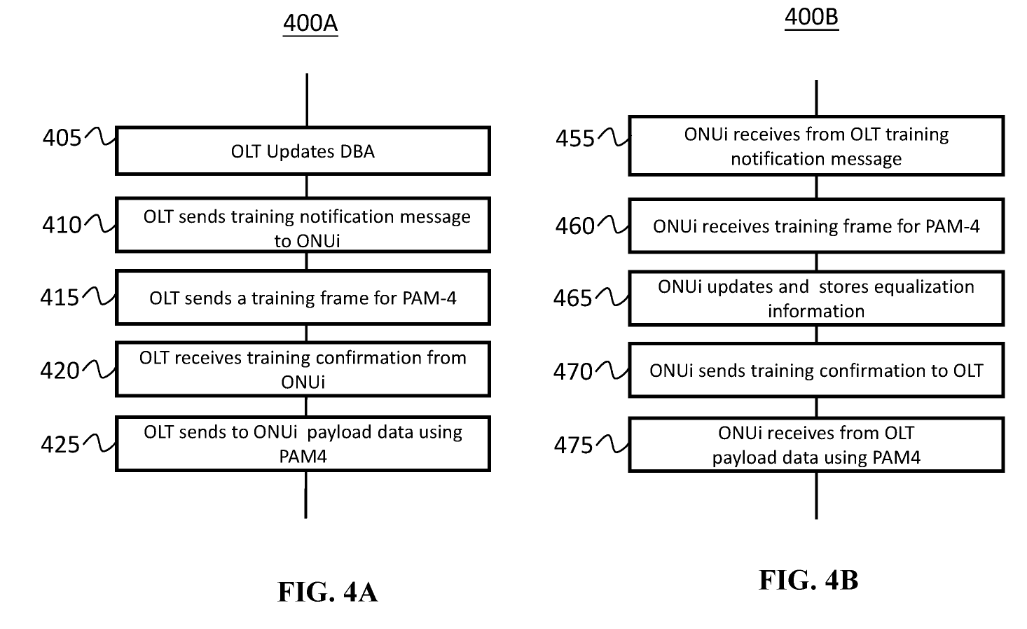

FIGS. 4A and 4B depict a process for determining the equalizer parameters for the downstream signal transmitted by the OLT and received by the ONUi. FIG. 4A depicts a process performed at the OLT and FIG. 4B depicts a process performed at the ONUi.

FIG. 4A depicts a process at the OLT for downstream equalization training performed at ONUi, in accordance with some example embodiments. The description of FIG. 4A also refers to FIGS. 1, 2, 3A, and 3B. Downstream equalization may include an equalizer at the ONUi receiver and/or predistortion of the signal transmitted by the OLT. Downstream equalization corrects the received signal at the ONUi. At 405, the OLT may update dynamic bandwidth allocation (DBA). At 410, the OLT may send training a notification message to ONUi. At 415, The OLT may send a training frame using a higher order modulation such as PAM4. At 420, the OLT may receive from ONUi a training confirmation message. At 425, the OLT may send to ONUi payload data using the higher order modulation corresponding to the modulation used in the training frame such as PAM4.

At 405, the OLT may update the dynamic bandwidth allocation (DBA). For example, the DBA may be updated to reflect the higher throughput of a higher order modulation with greater spectral efficiency. When PAM4 is used instead of NRZ-OOK, an increase in throughput using the same spectral allocation may be realized. The DBA may be updated accordingly.

At 410, the OLT may send training a notification message to ONUi. For example, the notification message may identify the modulation that will be used for the symbols in the training frame what will be sent after the notification message.

At 415, The OLT may send a training frame using a higher order modulation such as PAM4. The training frame includes a series of symbols known to the ONUi that are modulated according to the higher order modulation identified in the notification message.

At 420, the OLT may receive from ONUi a training confirmation message. After the ONUi has received and processed the training symbols to determine the equalizer and/or predistortion characteristics, ONUi may send a confirmation message to the OLT that the training is complete.

At 425, the OLT may send to ONUi payload data using the higher order modulation used in the training frame such as PAM4. Subsequent data may be sent using the higher order modulation. Accordingly, the downstream throughput may be increased.

FIG. 4B depicts a process for downstream equalization training performed at an ONU, in accordance with some example embodiments. The description of FIG. 4B also refers to FIGS. 1, 2, 3A, 3B, and 4A. Downstream equalization may include an equalizer at the ONUi receiver and/or pre-distortion of the signal transmitted by the transmitter at the OLT. Downstream equalization corrects the received signal at the ONUi. At 455, the ONUi may receive a training notification message from the OLT. At 460, the ONUi may receive a training frame using a higher order modulation such as PAM4. At t465, the ONUi may update and store equalization information. At 470, the ONUi may send a training confirmation message to the OLT. At 475, the ONUi may receive payload data using the higher order modulation corresponding to the modulation used in the training frame such as PAM4.

At 455, the ONUi may receive a training notification message from the OLT. For example, the notification message may identify the modulation that will be used for the symbols in the training frame what will be sent after the notification message.

At 460, the ONUi may receive a training frame using a higher order modulation such as PAM4. The training frame may include a series of symbols known to the ONUi that are modulated according to the higher order modulation identified in the notification message.

At 465, the ONUi may update and store equalization information. Based on the known training symbols and the received symbols, the equalizer may be trained by determine parameters such as weights. The determined parameters and/or weights may be stored at the ONUi.

At 470, the ONUi may send a training confirmation message to the OLT. After the ONUi has received and processed the training symbols to determine the equalizer and/or pre-distortion characteristics, ONUi may send a confirmation message to the OLT that the training is complete. In some example embodiments, sending the training confirmation at 470 may be excluded from process 400B.

At 475, the ONUi may receive payload data using the higher order modulation corresponding to the modulation used in the training frame such as PAM4. Subsequent data may be sent using the higher order modulation. Accordingly, the downstream throughput may be increased.

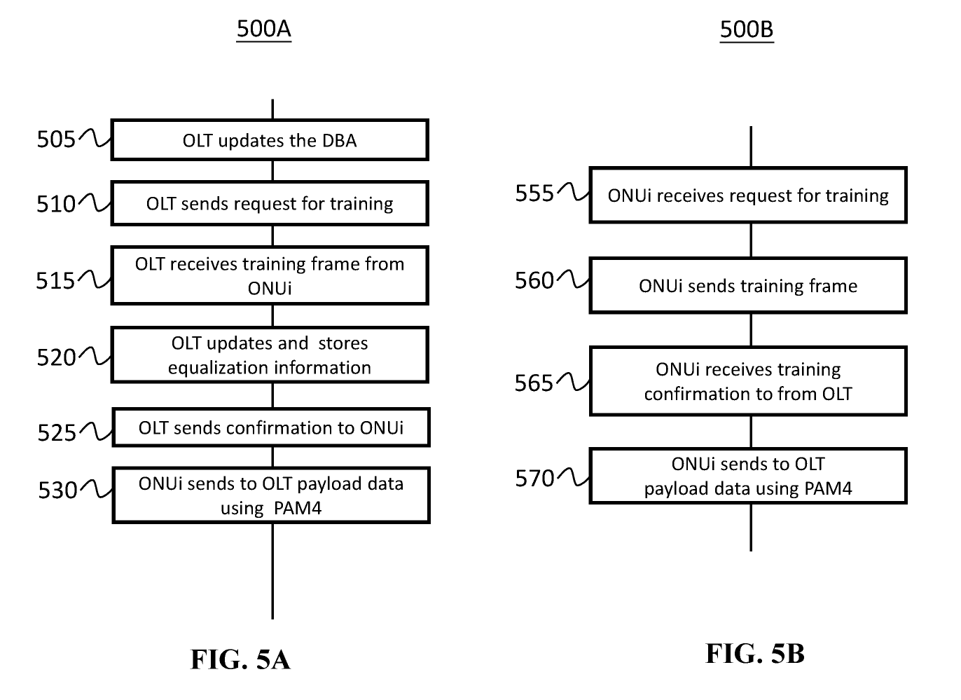

FIGS. 5A and 5B depict a process for determining the equalizer for the upstream signal transmitted by the ONUi and received by the OLT. FIG. 5A depicts a process performed at the OLT and FIG. 5B depicts a process performed at the ONUi.

FIG. 5A depicts a process for upstream equalization training performed at an OLT, in accordance with some example embodiments. The description of FIG. 5A also refers to FIGS. 1, 2, 3A, 3B, 4A, and 4B. At 505, the OLT may update the DBA. At 510, the OLT may send a request for equalizer training to the ONUi. At 515, the OLT receives a training frame from the ONUi. At 520, the OLT updates and stores the equalization information determined from the received symbols and the known transmitted symbols. At 525, the OLT sends a training confirmation to the ONUi. At 530, the ONUi sends payload data using the same modulation as the training frame such as PAM4.

At 505, the OLT may update the DBA. For example, the DBA may be updated to reflect the higher throughput of a higher order modulation with greater spectral efficiency. When PAM4 is used instead of NRZ-OOK, an increase in throughput using the same spectral allocation may be realized. The DBA may be updated accordingly.

At 510, the OLT may send a request for equalizer training to the ONUi. For example, the request message may identify the modulation that will be used for the symbols in the training frame what will be sent after the request message.

At 515, the OLT receives a training frame from the ONUi. The training frame includes a series of symbols known to the OLT that are modulated according to the higher order modulation identified in the notification message.

At 520, the OLT updates and stores the equalization information determined from the received symbols and the known transmitted symbols. The OLT may receive and process the training symbols to determine the equalizer and/or pre-distortion characteristics.

At 525, the OLT sends a training confirmation to the ONUi. The OLT may send a confirmation message to the ONUi that the training is complete. In some example embodiments, sending the training confirmation at 525 may be excluded from process 500A.

At 530, the ONUi sends payload data using the same modulation as the training frame such as PAM4. Subsequent data may be sent using the higher order modulation. Accordingly, the downstream throughput may be increased.

FIG. 5B depicts a process for upstream equalization training performed at an ONU, in accordance with some example embodiments. The description of FIG. 5B also refers to FIGS. 1, 2, 3A, 3B, 4A, 4B, and 5A. At 555, the ONUi may receive from the OLT a request for a training frame. At 560, the ONUi may send a training frame to the OLT. At 565. The ONUi may receive a training conformation message from the OLT. At 570, the ONUi may send to the OLT payload data using the higher order modulation of the training frame.

At 555, the ONUi may receive from the OLT a request for a training frame. For example, the request message may identify the modulation that will be used for the symbols in the training frame what will be sent after the notification message.

At 560, the ONUi may send a training frame to the OLT. The training frame may include a series of symbols known to the OLT that are modulated according to the higher order modulation identified in the notification message. Based on the known training symbols and the received symbols, the equalizer may be trained by determine parameters such as weights.

At 565. The ONUi may receive a training conformation message from the OLT. After the OLT has received and processed the training symbols to determine the equalizer and/or pre-distortion characteristics, the OLT may send a confirmation message to the ONUi that the training is complete. In some example embodiments, sending the training confirmation at 565 may be excluded from process 500B.

At 570, the ONUi may send to the OLT payload data using the higher order modulation of the training frame. Subsequent data may be sent using the higher order modulation. Accordingly, the downstream throughput may be increased.

As described above, upon registration an identifier for each ONUi may be stored at the OLT. After registration, the OLT may perform dynamic bandwidth allocation for each ONU. When multi-level signals are used, both downstream and upstream training may be performed to determine the equalizer parameters for the downstream receiver and the upstream receiver.

In some example embodiments, upstream and downstream communication during the registration process may use NRZ-OOK. Equalizer training for the downstream and upstream may be done in parallel or in serial. When performed in parallel, both the downstream training and the upstream training are performed at the same time or nearly the same time. When performed in serial, the downstream equalizer is trained followed by the upstream equalizer, or the upstream equalizer is trained followed by the downstream equalizer. For example, after registration, the OLT and the ONUi may send training frames to each other. In some example embodiments, the system may generate a rule that the downstream training process should be finished first, after which the upstream training is performed. In other example embodiments, the generated rule may be that the upstream training process should be finished first, and after which the downstream training process is performed. The benefit of using one of the foregoing rules is that the modulation formats of payload data can be pre-determined, depending on which training rule is used.

In some example embodiments, upstream and downstream communication during the registration process may use NRZ-OOK for the upstream registration process and use PAM-N (e.g., PAM4) for the downstream registration process. Serial training of the upstream and downstream equalizers may be performed. For example, the downstream equalizer training may be performed first. Downstream registration and training may include: 1) The OLT may periodically or intermittently broadcast a frame containing training symbols and information about the discovery window for registration; 2) The new ONUi may receive the downstream signals until the ONUi equalizer is trained and able to recover the information to perform registration; 3) ONUi may send the registration request to the OLT including an identifier for the ONUi using NRZ-OOK modulation; 4) The OLT may detect the registration request from the ONUi; 5) The OLT may update the DBA; 6) The OLT may send a confirmation to ONUi; and 7) The ONUi may send the acknowledgement (ACK) message to the OLT using NRZ-OOK modulation to finish the registration process.

Upstream training may include: 1) The OLT may send a request for upstream training to the ONUi; 2) The ONUi may send a training frame to the OLT; 3) The OLT may detect the training frame, update and store the equalization information such as equalizer weights for ONUi; 4) The OLT may send a training confirmation message to the ONUi after finishing the upstream training process; 5) The ONUi may send payload data based on the higher order modulation such as PAM4 to the OLT.

In the forgoing FIGS. 4A-5B, the modulation format of notification and request messages in 410, 455, 510, and 555 of the upstream and downstream training processes, may be NRZ-OOK or PAM4, depending on whether the downstream training or upstream training process is finished or not. The modulation format of confirmation signals in 420, 470, 525, and 565 of the upstream and downstream training processes, maybe NRZ-OOK or PAM4, depending on whether the downstream training or upstream training process is finished or not.

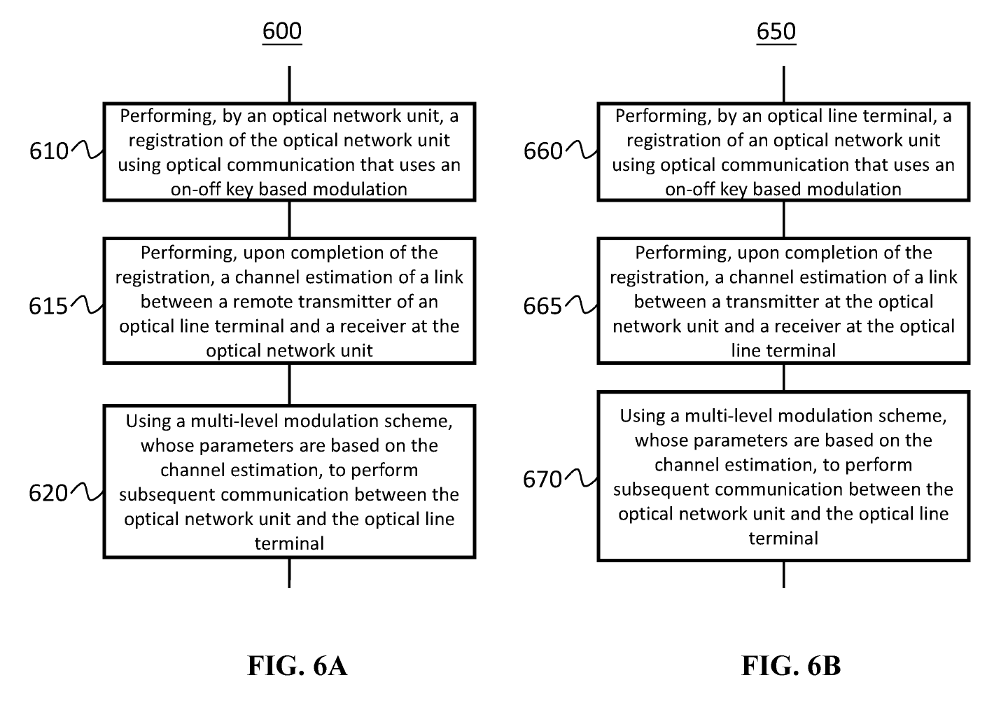

FIG. 6A depicts a process 600 performed at an optical network unit and FIG. 6B depicts a process performed at an optical line terminal, in accordance with some example embodiments. The description of FIGS. 6A and 6B also refer to FIGS. 1, 2, 3A, 3B, 4A, 4B, 5A, and 5B.

FIG. 6A at 600 depicts a process performed at an optical network unit. At 610 an optical network unit may perform a registration of the optical network unit at an optical line terminal using optical communication operating with an on-off key based modulation. The process at 610 may include features from FIG. 3B. At 615, upon completion of the registration, a channel estimation may be performed of a link between a remote transmitter of an optical line terminal and a receiver at the optical network unit. At 620, using a multi-level modulation scheme, whose parameters are based on the channel estimation, subsequent communication is performed between the optical network unit and the optical line terminal. The process at 615 and 620 may include features from FIGS. 4B and 5B. For example, in some embodiments, the multi-level scheme includes an N-level PAM system. In some embodiments, the channel estimation may use a training frame for the estimation. The training frame may be modulated according to a 4-level PAM. The channel estimation may result in determination of an equalizer for the 4-PAM signal. After the determination of the equalizer, a confirmation message may be sent to the OLT.

The method may further include sending a training frame for another channel estimation for the channel between a transmitter at the optical network unit and a remote receiver at the optical line terminal. In some embodiments, the above-described registration includes receiving information about a discovery time slot and sending a registration request message during the discovery time slot to cause registration of the optical network unit.

FIG. 6B at 650 depicts a process performed at an optical line terminal. At 660, an optical line terminal may perform a registration of an optical network unit using optical communication that uses an on-off key based modulation. The process at 660 may include features from FIG. 3A. At 665, upon completion of the registration, a channel estimation may be performed of a link between a transmitter at the optical network unit and a receiver at the optical line terminal. At 670, using a multi-level modulation scheme, whose parameters are based on the channel estimation, subsequent communication may be performed between the optical network unit and the optical line terminal. The process at 665 and 670 may include features from FIGS. 4A and 5A.

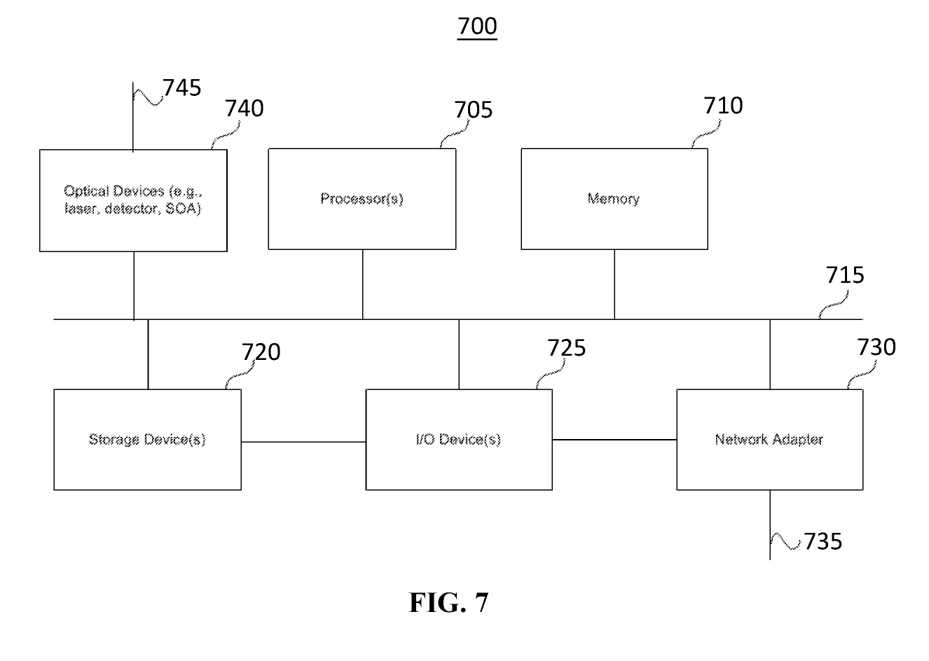

FIG. 7 depicts an apparatus, in accordance with some example embodiments. The description of FIG. 7 also refers to FIGS. 1, 2, 3A, 3B, 4A, 4B, 5A, 5B, 6A, and 6B.

In some embodiments, an optical networking system includes an OLT that includes a downstream optical transmitter, wherein the downstream optical transmitter transmits, in response to a request, a downstream equalizer training frame comprising modulated downstream symbols, an upstream optical receiver, wherein the upstream optical receiver receives an upstream equalizer training frame comprising modulated upstream symbols, and an upstream equalizer configured to equalize an upstream channel. In addition, the system may include one or more ONUs that are include a downstream optical receiver, wherein the downstream optical receiver receives the downstream equalizer training frame comprising the modulated downstream symbols, an upstream optical transmitter, wherein the upstream optical transmitter transmits, in response to another request, the upstream equalizer training frame comprising the modulated upstream symbols, and a downstream equalizer configured to equalize a downstream channel. Other features of the OLT and ONU are described throughout the present document.

Operations and management of the disclosed optical network unit such as optical network units 130A-130C and OLT 110 may include an apparatus such as 700. In an optical network unit, apparatus 700 may perform one or more of the processes described with respect to FIGS. 1-5B. Apparatus 700 may also perform other status and control functions and include interfaces to other devices. FIG. 7 at 700 is a block diagram of a computing system, consistent with various embodiments such as the OLT and/or ONU described above.

The apparatus 700 may include one or more central processing units (“processors”) 705, memory 710, input/output devices 725 (e.g., keyboard and pointing devices, display devices), storage devices 720 (e.g., disk drives or memory chips), and network adapters 730 (e.g., network interfaces) that are connected to an interconnect 715. Apparatus 700 may further include optical devices 740 including one or more of lasers, detectors, semiconductor amplifiers, and other optical and optoelectronic components. Optical devices 740 may connect to an optical line terminal, optical network unit via one or more fibers 745. The interconnect 715 is illustrated as an abstraction that represents any one or more separate physical buses, point to point connections, or both connected by appropriate bridges, adapters, or controllers. The interconnect 715, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The memory 710 and storage devices 720 are computer-readable storage media that may store instructions that implement at least portions of the described technology. In addition, the data structures and message structures may be stored or transmitted via a data transmission medium, such as a signal on a communications link. Various communications links may be used, such as the Internet, a local area network, a wide area network, or a point-to-point dial-up connection. Thus, computer-readable media can include computer-readable storage media (e.g., “non-transitory” media) and computer-readable transmission media.

The instructions stored in memory 710 can be implemented as software and/or firmware to program the processor(s) 705 to carry out actions described above. In some embodiments, such software or firmware may be initially provided to the processing system 700 by downloading it from a remote system through the computing system 700 (e.g., via network adapter 730 or optical devices 740).

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments. Accordingly, the embodiments are not limited except as by the appended claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Terms that are used to describe the disclosure are discussed below, or elsewhere in the specification, to provide additional guidance to the practitioner regarding the description of the disclosure. For convenience, some terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for some terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method of digital communication, comprising:
performing, by an optical network unit, a registration of the optical network unit using optical communication that uses an on-off key based modulation;
performing, upon completion of the registration, a channel estimation of a link between a remote transmitter of an optical line terminal and a receiver at the optical network unit; and
using a multi-level modulation scheme, whose parameters are based on the channel estimation, to perform subsequent communication between the optical network unit and the optical line terminal.

2. The method of claim 1, wherein the multi-level scheme comprises an N-level pulse amplitude modulation, wherein N is an integer.

3. The method of claim 1, wherein the channel estimation is based on a training frame received from the optical line terminal.

4. The method of claim 3, wherein the training frame is modulated according to a four level pulse amplitude modulation, and wherein the channel estimation determines an equalizer for the four level pulse amplitude modulation.

5. The method of claim 1, wherein after the equalizer is determined, a confirmation message is sent by the optical network unit to the optical line terminal.

6. The method of claim 1, further comprising:
sending, by the optical network unit, a training frame for another channel estimation between a transmitter at the optical network unit and a remote receiver at the optical line terminal.

7. The method of claim 1, wherein the registration includes receiving information about a discovery time slot and sending a registration request message during the discovery time slot to cause registration of the optical network unit.

8. A method of digital communication, comprising:
performing, by an optical line terminal, a registration of an optical network unit using optical communication that uses an on-off key based modulation;
performing, upon completion of the registration, a channel estimation of a link between a transmitter at the optical network unit and a receiver at the optical line terminal; and
using a multi-level modulation scheme, whose parameters are based on the channel estimation, to perform subsequent communication between the optical network unit and the optical line terminal.

9. The method of claim 8, wherein the optical line terminal communicates with a plurality of optical network units including the optical network unit, wherein communications to each of the plurality of optical network units is separated by time.

10. The method of claim 8, wherein the optical line terminal communicates with a plurality of optical network units including the optical network unit, wherein communications to each of the plurality of optical network units is separated by wavelength.

11. The method of claim 8, wherein the multi-level scheme comprises an N-level pulse amplitude modulation, wherein N is an integer.

12. The method of claim 8, wherein the channel estimation is based on a training frame received from the optical network unit.

13. The method of claim 12, wherein the training frame is modulated according to a four level pulse amplitude modulation, and wherein the channel estimation determines an equalizer for the four level pulse amplitude modulation.

14. The method of claim 8, wherein after the equalizer is determined, a confirmation message is sent by the optical line terminal to the optical network unit.

15. The method of claim 8, wherein the registration includes sending information about a discovery time slot and receiving a registration request message during the discovery time slot to cause registration of the optical network unit.

16. An optical networking system comprising:
an optical line terminal comprising:
a downstream optical transmitter, wherein the downstream optical transmitter transmits, in response to a request, a downstream equalizer training frame comprising modulated downstream symbols;
an upstream optical receiver, wherein the upstream optical receiver receives an upstream equalizer training frame comprising modulated upstream symbols; and
an upstream equalizer configured to equalize an upstream channel.

17. The optical networking system of claim 16, further comprising:
an optical network unit comprising:
a downstream optical receiver, wherein the downstream optical receiver receives the downstream equalizer training frame comprising the modulated downstream symbols;
an upstream optical transmitter, wherein the upstream optical transmitter transmits, in response to another request, the upstream equalizer training frame comprising the modulated upstream symbols; and
a downstream equalizer configured to equalize a downstream channel.

18. The optical networking system of claim 17, wherein an upstream registration is performed using an on-off keying modulation and a downstream registration is performed using a N-level pulse amplitude modulation (N-PAM), and wherein N is a positive integer.

19. The optical networking system of claim 17, wherein the downstream equalizer is trained via the downstream equalizer training frame before the upstream equalizer is trained via the upstream equalizer training frame.

20. The optical networking system of claim 18, wherein during the downstream registration the optical line terminal periodically or intermittently broadcasts the downstream equalizer training frame including training symbols and an indication of a time window when registration requests are processed.

21. The optical networking system of claim 20, wherein the optical network unit receives and processes the downstream equalizer training frame until the downstream equalizer is trained and able to perform registration.

22. The optical networking system of claim 21, wherein the optical network unit sends a registration request in the time window to the optical line terminal including an identifier associated with the optical network unit.

23. The optical networking system of claim 22, wherein the optical line terminal detects the registration request from the optical network unit, updates a dynamic bandwidth allocation, and sends a confirmation to the optical network unit.

24. The optical networking system of claim 23, wherein the optical network unit sends an acknowledgement (ACK) message to the optical line terminal to finish the downstream registration.

25. The optical networking system of claim 17, wherein the upstream equalizer training frame is sent from the optical network unit to the optical line terminal before the downstream equalizer training frame is sent from the optical line terminal to the optical network unit.

26. The optical networking system of claim 17, wherein the upstream equalizer training frame is sent from the optical network unit to the optical line terminal at a same time as the downstream equalizer training frame is sent from the optical line terminal to the optical network unit.

27. The optical networking system of claim 17, wherein weights associated with the downstream equalizer are adjusted in response to the modulated downstream symbols received at the optical network unit.

28. The optical networking system of claim 17, wherein weights associated with the upstream equalizer are adjusted in response to the modulated upstream symbols received at the optical line terminal.

29. The optical networking system of claim 17, wherein the upstream optical transmitter further transmits upstream payload data according to an on-off keying modulation or a multi-level pulse amplitude modulation, and wherein the downstream optical transmitter transmits downstream payload data according to the multi-level pulse amplitude modulation or the on-off keying modulation.
